(19) United States
(12) Patent Application Publication
(10) Pub. No.: US 2023/0062944 A1
(43) Pub. Date: Mar. 2, 2023

(54) POLY(CARBONATE-SILOXANE) COMPOSITIONS WITH IMPROVED APPEARANCE

(71) Applicant: SHPP GLOBAL TECHNOLOGIES B.V., Bergen op Zoom (NL)

(72) Inventors: Peter Vollenberg, Evansville, IN (US); Christopher Luke Hein, Evansville, IN (US); Laura Mely Ramirez, Evansville, IN (US)

(21) Appl. No.: 17/796,783

(22) PCT Filed: Feb. 10, 2021
(86) PCT No.: PCT/US2021/017451

§ 371 Date: Aug. 1, 2022

(30) Foreign Application Priority Data
Feb. 10, 2020 (EP) 20156498.6

(51) Int. Cl. C08G 64/18; C08G 64/06; C08G 77/448; C08K 3/04; C08K 3/30; C08K 3/22; C08K 5/00

(52) U.S. Cl. CPC C08G 64/186; C08G 64/06; C08G 77/448; C08K 3/04; C08K 3/30; C08K 3/22; C08K 5/0041; C08K 2003/3009; C08K 2003/2241; C08G 2261/11; C08G 2261/12; C08G 2261/22

(57) ABSTRACT

A poly(carbonate-siloxane) composition comprising: a poly(carbonate-siloxane) copolymer comprising carbonate units and siloxane units, wherein a siloxane content is greater than 25 wt % to less than 70 wt %, based on the total weight of the poly (carbonate-siloxane) copolymer and wherein the weight average molecular weight of the poly (carbonate-siloxane) copolymer is greater than 30,000 g/mol, as measured by gel permeation chromatography using a crosslinked styrene-divinyl benzene column, using polystyrene standards and calibrated for polycarbonate; a homopolycarbonate comprising a bisphenol A homopolycarbonate; a colorant composition comprising an organic colorant, an inorganic pigment, or a combination thereof, wherein the colorant composition optionally comprises titanium dioxide in an amount of 0.8 wt % or less; optionally, a flame retardant; optionally, an anti-drip agent; optionally, an additive composition, wherein an average siloxane domain size is less than 100 nanometers as determined by scanning electron microscopy, nd a molded sample of the poly(carbonate-siloxane) composition is substantially free of pearlescence.

### CROSS REFERENCE TO RELATED APPLICATIONS

This application claims the benefit of EP Application No. 20156498.6, filed on Feb. 10, 2020, which is incorporated herein by reference in its entirety.

### BACKGROUND

This disclosure relates to polycarbonate compositions, and in particular to poly(carbonate-siloxane) compositions, methods of manufacture, and uses thereof.

Polycarbonates are useful in the manufacture of articles and components for a wide range of applications, from automotive parts to electronic appliances. Because of their broad use, particularly in colored formulations, it is desirable to provide polycarbonates with improved appearance.

There accordingly remains a need in the art for colored polycarbonate compositions in which pearlescence of molded articles made from the colored polycarbonate compositions is minimized or eliminated. It would be a further advantage if the compositions had chemical resistance, impact resistance, and low temperature ductility.

### SUMMARY

The above-described and other deficiencies of the art are met by a poly(carbonate-siloxane) composition comprising: a poly(carbonate-siloxane) copolymer having a siloxane content of greater than 25 wt % to less than 70 wt %, based on the total weight of the poly(carbonate-siloxane) copolymer and having a weight average molecular weight of greater than 30,000 g/mol, as measured by gel permeation chromatography using a crosslinked styrene-divinyl benzene column, using polystyrene standards and calibrated for polycarbonate; a homopolycarbonate comprising a bisphenol A homopolycarbonate; a colorant composition comprising an organic colorant, an inorganic pigment, or a combination thereof, wherein the colorant composition optionally comprises titanium dioxide in an amount of 0.8 wt % or less; optionally, a flame retardant; optionally, an anti-drip agent; optionally, an additive composition, wherein an average siloxane domain size is less than 100 nanometers as determined by scanning electron microscopy.

In another aspect, a method of manufacture comprises combining the above-described components to form a poly(carbonate-siloxane) composition.

In yet another aspect, an article comprises the above-described poly(carbonate-siloxane) composition.

In still another aspect, a method of manufacture of an article comprises molding, extruding, or shaping the above-described poly(carbonate-siloxane) composition into an article.

The above described and other features are exemplified by the following drawings, detailed description, examples, and claims.

### BRIEF DESCRIPTION OF THE DRAWINGS

The following is a brief description of the drawings wherein like elements are numbered alike and which are exemplary of the various aspects described herein.

FIGS. 1A-1D show scanning electron micrograph (SEM) photographs taken at 50,000 magnification of poly(carbonate-siloxane) compositions including poly(carbonate-siloxane) and BPA homopolycarbonate. FIG. 1A shows a SEM micrograph where the poly(carbonate-siloxane) has a siloxane content of 20 wt %, resulting in siloxane domains having an average size of greater than 100 nm. FIG. 1B shows a SEM micrograph where the poly(carbonate-siloxane) has a siloxane content of 40 wt % and the weight average molecular weight of 30,000 grams per mole, as determined using polystyrene standards and calculated for polycarbonate, which also resulted in siloxane domains having an average size of greater than 100 nm. FIGS. 1C-1D show SEM micrographs wherein the poly(carbonate-siloxane) has a siloxane content of 40 wt % and the weight average molecular weight is 37,000-38,000 g/mol for FIG. 1C and 45,000 g/mol for FIG. 1D.

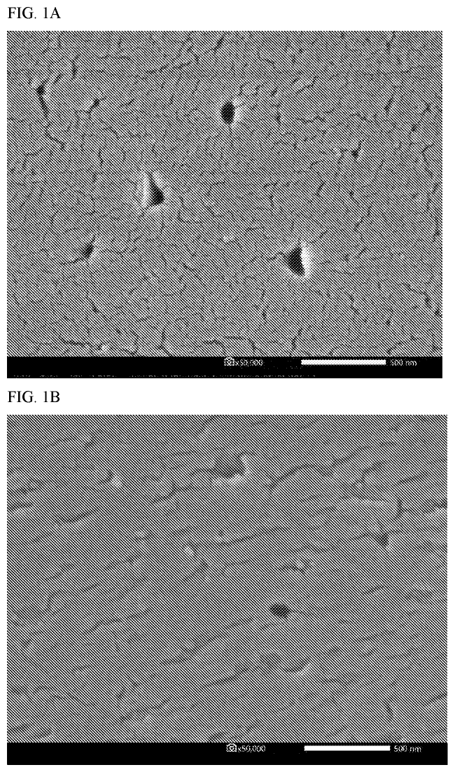

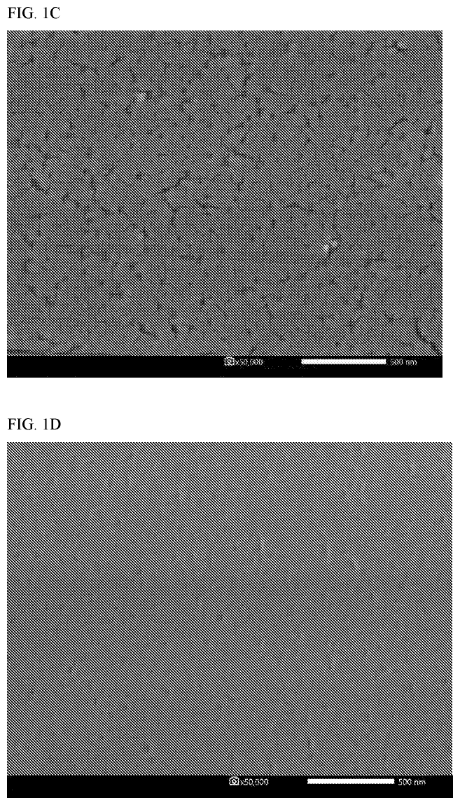

### DETAILED DESCRIPTION

Compositions made with conventional poly(carbonate-siloxane)s having a 20 wt % siloxane content can provide desired properties such as low temperature ductility and chemical resistance but result in compositional variation within colored formulations. As a result, use of such formulations have restrictive color formulation limitations. In addition, molded parts made from 20 wt % siloxane content poly(carbonate-siloxane) compositions undesirably exhibit a pearlescent appearance.

The inventors hereof have discovered that compositions including a poly(carbonate-siloxane) copolymer having a siloxane content ranging from greater than 25 wt % to 70 wt % (based on the total weight of the copolymer) and having a weight average molecular weight of greater than 30,000 g/mol, as measured by gel permeation chromatography using a crosslinked styrene-divinyl benzene column, using polystyrene standards and calibrated for polycarbonate, a homopolycarbonate comprising bisphenol A polycarbonate, and a colorant composition comprising an organic colorant, an inorganic pigment, or a combination thereof, wherein the average domain size is less than 100 nanometers provided molded parts and wherein a molded sample of the composition is substantially free of pearlescence. Advantageously, the poly(carbonate-siloxane) compositions provide color freedom in that a range of colors have been made available, including, for example, achromatic colors such as jet-black as well as chromatic colors.

The individual components of the poly(carbonate-siloxane) compositions are described in more detail below.

“Polycarbonate” as used herein means a polymer having repeating structural carbonate units of formula (1)

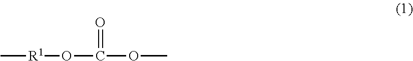

in which at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ can be derived from an aromatic dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In an aspect, one atom separates A¹ from A². Preferably, each R¹ can be derived from a bisphenol of formula (3)

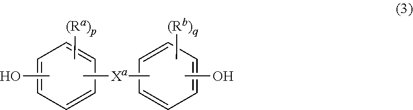

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also, in formula (3), X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂—, —C(O)—, or a C₁₋₆₀ organic group. The organic bridging group can be cyclic or acyclic, aromatic or non-aromatic, and can further comprise heteroatoms such as halogens, oxygen, nitrogen, sulfur, silicon, or phosphorous. The C₁₋₆₀ organic group can be disposed such that the C₆ arylene groups connected thereto are each connected to a common alkylidene carbon or to different carbons of the C₁₋₆₀ organic bridging group. In an aspect, p and q is each 1, and R^{a} and R^{b} are each a C₁₋₃ alkyl group, preferably methyl, disposed meta to the hydroxy group on each arylene group.

In an aspect, X^{a} is a C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, heteroalkyl, or cyclic C₇₋₁₂ heteroarylalkyl, or a group of the formula —C(═R^{e})— wherein R^{e} is a divalent C₁₋₁₂ hydrocarbon group. Groups of these types include methylene, cyclohexylmethylidene, ethylidene, neopentylidene, and isopropylidene, as well as 2-[2.2.1]-bicycloheptylidene, cyclohexylidene, 3,3-dimethyl-5-methylcyclohexylidene, cyclopentylidene, cyclododecylidene, and adamantylidene.

In another aspect, X^{a} is a C₁₋₁₈ alkylene, a C₃₋₁₈ cycloalkylene, a fused C₆₋₁₈ cycloalkylene, or a group of the formula -J¹-G-J²- wherein J¹ and J² are the same or different C₁₋₆ alkylene and G is a C₃₋₁₂ cycloalkylidene or a C₆₋₁₆ arylene.

For example, X^{a} can be a substituted C₃₋₁₈ cycloalkylidene of formula (4)

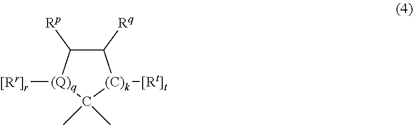

wherein R^{r}, R^{p}, R^{q}, and R^{t} are each independently hydrogen, halogen, oxygen, or C₁₋₁₂ hydrocarbon groups; Q is a direct bond, a carbon, or a divalent oxygen, sulfur, or —N(Z)— where Z is hydrogen, halogen, hydroxy, C₁₋₁₂ alkyl, C₁₋₁₂ alkoxy, C₆₋₁₂ aryl, or C₁₋₁₂ acyl; r is 0 to 2, t is 1 or 2, q is 0 or 1, and k is 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (4) will have an unsaturated carbon-carbon linkage where the ring is fused. When k is one and q is 0, the ring as shown in formula (4) contains 4 carbon atoms, when k is 2, the ring as shown in formula (4) contains 5 carbon atoms, and when k is 3, the ring contains 6 carbon atoms. In an aspect, two adjacent groups (e.g., R^{q} and R^{t} taken together) form an aromatic group, and in another aspect, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone, or Q can be —N(Z)— wherein Z is phenyl.

Bisphenols wherein X^{a} is a cycloalkylidene of formula (4) can be used in the manufacture of polycarbonates containing phthalimidine carbonate units of formula (1a)

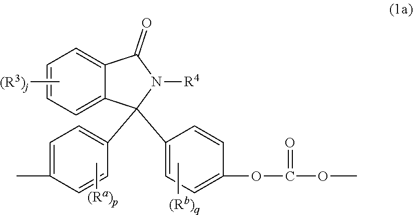

wherein R^{a}, R^{b}, p, and q are as in formula (3), R³ is each independently a C₁₋₆ alkyl, j is 0 to 4, and R₄ is hydrogen, C₁₋₆ alkyl, or a substituted or unsubstituted phenyl, for example a phenyl substituted with up to five C₁₋₆ alkyls. For example, the phthalimidine carbonate units are of formula (1b)

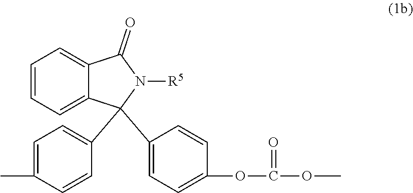

wherein R⁵ is hydrogen, phenyl optionally substituted with up to five 5 C₁₋₆ alkyls, or C₁₋₄ alkyl. In an aspect in formula (1b), R⁵ is hydrogen, methyl, or phenyl, preferably phenyl. Carbonate units (1b) wherein R⁵ is phenyl can be derived from 2-phenyl-3,3′-bis(4-hydroxy phenyl)phthalimidine (also known as 3,3-bis(4-hydroxyphenyl)-2-phenylisoindolin-1-one, or N-phenyl phenolphthalein bisphenol (“PPPBP”)).

Other bisphenol carbonate repeating units of this type are the isatin carbonate units of formula (1c) and (1d)

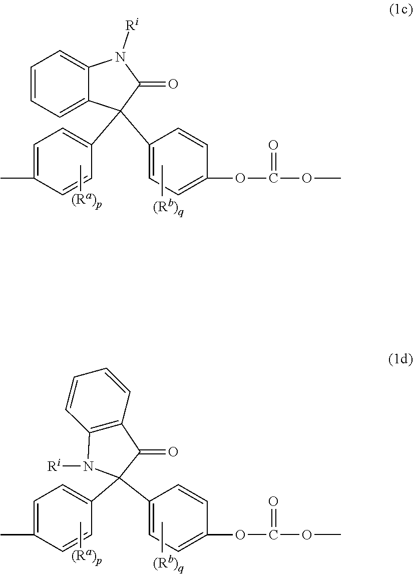

wherein R^{a} and R^{b} are each independently a halogen, C₁₋₁₂ alkoxy, or C₁₋₁₂ alkyl, p and q are each independently 0 to 4, and R′ is C₁₋₁₂ alkyl, phenyl optionally substituted with 1 to 5 C₁₋₁₀ alkyl, or benzyl optionally substituted with 1 to 5 C₁₋₁₀ alkyl. In an aspect, R^{a} and R^{b} are each methyl, p and q are each independently 0 or 1, and R′ is C₁₋₄ alkyl or phenyl.

Other examples of bisphenol carbonate units derived from of bisphenols (3) wherein X^{a} is a substituted or unsubstituted C₃₋₁₈ cycloalkylidene include the cyclohexylidene-bridged bisphenol of formula (1e)

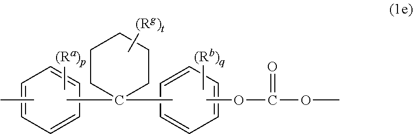

wherein R^{a} and R^{b} are each independently C₁₋₁₂ alkyl, R^{g} is C₁₋₁₂ alkyl, p and q are each independently 0 to 4, and t is 0 to 10. In a specific aspect, at least one of each of R^{a} and R^{b} are disposed meta to the cyclohexylidene bridging group. In an aspect, R^{a} and R^{b} are each independently C₁₋₄ alkyl, R^{g} is C₁₋₄ alkyl, p and q are each 0 or 1, and t is 0 to 5. In another specific aspect, R^{a}, R^{b}, and R^{g} are each methyl, p and q are each 0 or 1, and t is 0 or 3, preferably 0. In still another aspect, p and q are each 0, each R^{g} is methyl, and t is 3, such that X^{a} is 3,3-dimethyl-5-methyl cyclohexylidene.

Examples of other bisphenol carbonate units derived from bisphenol (3) wherein X′ is a substituted or unsubstituted C₃₋₁₈ cycloalkylidene include adamantyl units of formula (1f) and fluorenyl units of formula (1g)

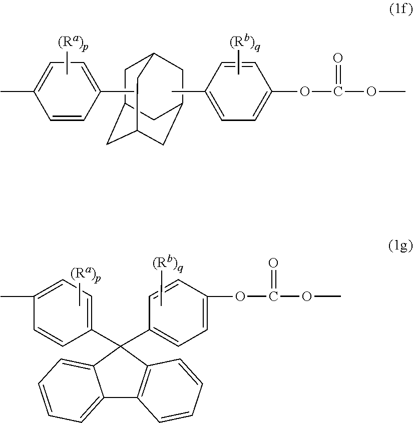

wherein R^{a} and R^{b} are each independently C₁₋₁₂ alkyl, and p and q are each independently 1 to 4. In a specific aspect, at least one of each of R^{a} and R^{b} are disposed meta to the cycloalkylidene bridging group. In an aspect, R^{a} and R^{b} are each independently C₁₋₃ alkyl, and p and q are each 0 or 1; preferably, R^{a}, R^{b} are each methyl, p and q are each 0 or 1, and when p and q are 1, the methyl group is disposed meta to the cycloalkylidene bridging group. Carbonates containing units (1a) to (1g) are useful for making polycarbonates with high glass transition temperatures (Tg) and high heat distortion temperatures.

Other useful dihydroxy compounds of the formula HO—R¹—OH include aromatic dihydroxy compounds of formula (6)

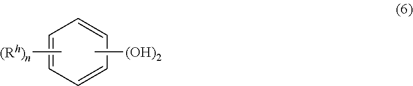

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen is usually bromine.

Some illustrative examples of specific dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl) naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or a combination thereof.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). A combination can also be used. In a specific aspect, the homopolycarbonate is a linear homopolymer derived from bisphenol A, in which each of A¹ and A² is p-phenylene and Y¹ is isopropylidene in formula (3).

The homopolycarbonates can have an intrinsic viscosity, as determined in chloroform at 25° C., of 0.3 to 1.5 deciliters per gram (dl/gm), preferably 0.45 to 1.0 dl/gm. The homopolycarbonates can have a weight average molecular weight (Mw) of 10,000 to 200,000 g/mol, preferably 20,000 to 100,000 g/mol, as measured by gel permeation chromatography (GPC), using a crosslinked styrene-divinylbenzene column and calibrated to bisphenol A homopolycarbonate references. In some aspects, the homopolycarbonate is a bisphenol A homopolycarbonate having a weight average molecular weight of 18,000 to 23,000 g/mol; a weight average molecular weight of 27,000 to 35,000 g/mol; or a combination thereof, as measured by gel permeation chromatography (GPC), using a crosslinked styrene-divinylbenzene column and using polystyrene standards and calculated for polycarbonate. The GPC samples are prepared at a concentration of 1 mg per ml and are eluted at a flow rate of 1.5 ml per minute.

The homopolycarbonates can be manufactured by processes such as interfacial polymerization and melt polymerization, which are known, and are described, for example, in WO 2013/175448 A1 and WO 2014/072923 A1. An end-capping agent (also referred to as a chain stopper agent or chain terminating agent) can be included during polymerization to provide end groups, for example monocyclic phenols such as phenol, p-cyanophenol, and C₁₋₂₂ alkyl-substituted phenols such as p-cumyl-phenol, resorcinol monobenzoate, and p- and tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups can be used. Branched polycarbonate blocks can be prepared by adding a branching agent during polymerization, for example trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05 to 2.0 wt. %. Combinations comprising linear polycarbonates and branched polycarbonates can be used.

The homopolycarbonate can be present from 70-95 wt %, 75-95 wt %, 80-95 wt %, 85-95 wt %, 70-90 wt %, 70-85 wt %, or 70-80 wt %, each based on the total weight of the poly(carbonate-siloxane) composition.

The poly(carbonate-siloxane) compositions include poly(carbonate-siloxane) copolymers comprising carbonate blocks and siloxane blocks. The carbonate blocks comprise repeating structural carbonate units of formula (1)

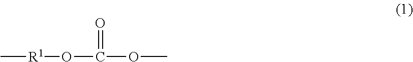

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

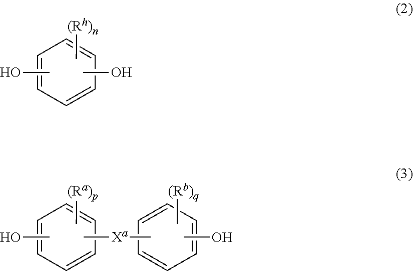

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an aspect, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{a})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group. Exemplary bisphenols include: 2,2-bis(4-hydroxyphenyl)propane (hereinafter “bisphenol-A” or “BPA”), tetrabromo bisphenol A, 2,2-bis(3,5-dimethyl-4-hydroxyphenyl)propane, 4,4′-dihydroxydiphenyl ether, resorcinol, hydroquinone, t-butyl hydroquinone, 1,1-bis(4-hydroxyphenyl)methane, 1,1-bis(4-hydroxyphenyl)ethane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, 2,2-bis(4-hydroxy-1-methylphenyl)propane, 1,1-bis(4-hydroxy-t-butylphenyl)propane and cyclohexyl BPA. Combinations comprising at least one of the foregoing dihydroxy compounds can also be used. Poly(carbonate-siloxane) copolymers may be linear or branched copolymers for example branched copolymer resins using: trimellitic acid, trimellitic anhydride, trimellitic trichloride, tris-p-hydroxy phenyl ethane (THPE), isatin-bis-phenol, tris-phenol TC (1,3,5-tris((p-hydroxyphenyl)isopropyl)benzene), tris-phenol PA (4(4(1,1-bis(p-hydroxyphenyl)ethyl)alpha, alpha-dimethyl benzyl)phenol), 4-chloroformyl phthalic anhydride, trimesic acid, and benzophenone tetra carboxylic acid.

Some illustrative examples of dihydroxy compounds that can be used are described, for example, in WO 2013/175448 A1, US 2014/0295363, and WO 2014/072923. In a specific aspect, the polycarbonate units are derived from bisphenol-A. In another specific aspect, the polycarbonate units are derived from resorcinol and bisphenol-A in a molar ratio of resorcinol carbonate units to bisphenol-A carbonate units of 1:99 to 99:1.

The siloxane blocks comprise diorganosiloxane units of Formula (4)

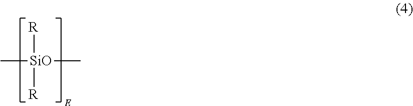

wherein each R is, independently, a C₁₋₁₃ monovalent organic group; and E has an average value of 5 to 100. For example, R can be a C₁₋₁₃ alkyl, C₁₋₁₃ alkoxy, C₂₋₁₃ alkenyl, C₂₋₁₃ alkenyloxy, 6 cycloalkyl, C₃₋₆ cycloalkoxy, C₆₋₁₄ aryl, C₆₋₁₀ aryloxy, C₇₋₁₃ arylalkylene, or C₇₋₁₃ alkylarylene. The foregoing groups can be fully or partially halogenated with fluorine, chlorine, bromine, or iodine, or a combination comprising at least one of the foregoing halogens. In an aspect, where a transparent polysiloxane-polycarbonate is, R is unsubstituted by halogen. Combinations of the foregoing R groups can be used in the same copolymer. The notation “Dn” is used herein to refer to the average number of diorganosiloxane units; for example, D45 means that the silicone blocks have an average value of E of 45.

In an aspect, the polydiorganosiloxane blocks are of formula (5) or (6)

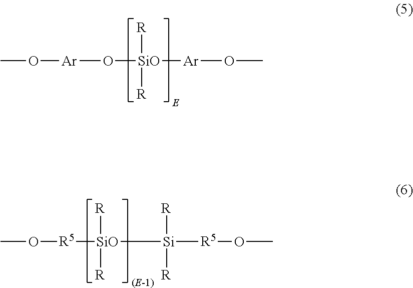

wherein E is as defined in formula (4) and each R can be the same or different, and is as defined in formula (4). In formula (5), Ar can be the same or different, and is a substituted or unsubstituted C₆₋₃₀ arylene, wherein the bonds are directly connected to an aromatic moiety. The Ar groups in formula (15) can be derived from a C₆₋₃₀ dihydroxyarylene compound, for example a dihydroxyarylene compound of formula (2) or (3) above, such as 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), tetrabromo bisphenol A, and 1,1-bis(4-hydroxy-t-butylphenyl) propane. Combinations comprising at least one of the foregoing dihydroxy compounds can also be used. In formula (6), each R⁵ is independently a divalent C₁₋₃₀ organic group, specifically a C₇₋₃₀ alkylenearylene wherein the alkylene group is attached to the silicone and the arylene. In a specific aspect, the polydiorganosiloxane blocks are of formula (7)

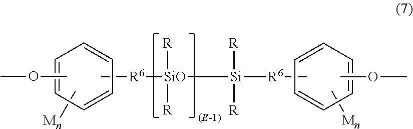

wherein R and E are as defined in formula (4), R⁶ is a divalent C₂-C₈ aliphatic group, each M can independently be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ arylalkylene, or C₇₋₁₂ alkylarylene and each n is independently the same or different, and is 0, 1, 2, 3, or 4. In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene, or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, R⁶ is a divalent C₁-C₃ aliphatic group. In an aspect, the poly(carbonate-siloxane) copolymers are prepared by the reaction of at least one dihydroxy-terminated-polydiorganosiloxane corresponding to formulas (5), (6), or (7) having from 5 to 80 siloxane repeat units, at least one bisphenol of formula (3), and a carbonate precursor.

The siloxane blocks can have a glass transition temperature of minus 130 to 50° C., or minus 130 to minus 50° C. The polycarbonate blocks can have a glass transition temperature greater than 70° C. The poly(carbonate-siloxane) copolymers can have a weight average molecular weight (M_{w}) of greater than 30,000 to 100,000 g/mol, preferably greater than 30,000 to 50,000 g/mol, more preferably greater than 30,000 to 45,000 g/mol, each as measured by gel permeation chromatography using polycarbonate standards. The inventors hereof discovered that when poly(carbonate-siloxane)s having a molecular weight of greater than 30,000 g/mol when used in combination with homopolycarbonate provided molded samples wherein pearlescence was minimized or eliminated. Without wishing to be bound by theory, when a poly(carbonate-siloxane) having a molecular weight of 30,000 or less is incorporated into the compositions, some domains having an average domain size of 100 nm or greater result, which contributes to the pearlescent effect. However, compositions having a molecular weight of greater than 30,000 (e.g. 37,000 to 38,000 or 45,000) did not result in an average domain size of exceeding 100 nm when measured using scanning electron micrographs (SEM).

The poly(carbonate-siloxane) copolymers can be present from 5-30 wt %, 5-25 wt %, 5-20 wt %, 5-15 wt %, 10-30 wt %, 10-25 wt %, 10-20 wt %, each based on the total weight of the composition. The poly(carbonate-siloxane) copolymers can have a siloxane content of greater than 25 to 70 wt %, greater than 25 to 65 wt %, greater than 25 to 60 wt %, 30-70 wt %, 30-65 wt %, 30-60 wt %, 30-50 wt %, 35-65 wt %, 35-60 wt %, or 35-55 wt %, each based on the total weight of the poly(carbonate-siloxane) copolymer.

The poly(carbonate-siloxane) copolymer can be used in combination with one or more additional poly(carbonate-siloxane) copolymers having a different siloxane content. In some aspects, the additional poly(carbonate-siloxane) copolymer can have a siloxane content of 25 wt % or less, 20 wt % or less, for example, 25 wt %, 20 wt %, or 6 wt %. In some aspects, the poly(carbonate-siloxane) compositions are free of a poly(carbonate-siloxane) copolymer having a siloxane content of 20 wt % or less.

The poly(carbonate-siloxane) compositions include a colorant composition. The inventors hereof unexpectedly discovered that when a colorant composition is present in combination with the homopolycarbonate and the poly(carbonate-siloxane) having a siloxane content of 25-70 wt % siloxane and a weight average molecular weight of greater than 30,000 grams per mole, that pearlescence can be minimized or eliminated. The colorant composition can include an organic colorant, an inorganic pigment, or a combination thereof. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Red 265, Pigment Violet 29, Pigment Blue 15, Pigment Blue 60, Pigment Green 50, Pigment Green 7, Pigment Yellow 119, Pigment Yellow 147, Pigment Yellow 150, and Pigment Brown 24; or a combination thereof.

The colorant composition can include an organic colorant. In some aspects, the organic colorant includes carbon black. In some aspects, the colorant composition includes an organic colorant such as a dye. Non-limiting examples of dyes include coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or a combination thereof. In some aspects, the organic colorant comprises copper phthalocyanine (e.g., Pigment Blue 15.4), perinone (e.g., Solvent Red 135), anthraquinone (e.g., Solvent Green 3), or a combination thereof.

The colorant composition includes an organic colorant, an inorganic pigment, or a combination thereof and optionally includes titanium dioxide in an amount of 0.8 wt % or less based on the total weight of the poly(carbonate-siloxane) composition. When present, the titanium dioxide is present in an amount of 0.8 wt % or less, 0.7 wt % or less, 0.6 wt % or less, 0.5 wt % or less, 0.4 wt % or less, 0.3 wt % or less, 0.2 wt % or less, or 0.1 wt % or less. In some aspects, the organic colorant can be present from 0.001-3 wt %, 0.005-3 wt %, 0.01-3 wt %, 0.05-3 wt %, or 0.1-3 wt %, 0.001-1.5 wt %, 0.005-1.5 wt %, 0.01-1.5 wt %, 0.05-1.5 wt %, or 0.1-1.5 wt %, each based on the total weight of the poly(carbonate-siloxane) composition. In some aspects, the inorganic pigment can be present from 0.001-3 wt %, 0.005-3 wt %, 0.01-3 wt %, 0.05-3 wt %, or 0.1-3 wt %, 0.001-1.5 wt %, 0.005-1.5 wt %, 0.01-1.5 wt %, 0.05-1.5 wt %, or 0.1-1.5 wt %, each based on the total weight of the poly(carbonate-siloxane) composition. In some aspects, the poly(carbonate-siloxane) compositions are substantially free of titanium dioxide. As used herein, “substantially free of titanium dioxide” means that the poly(carbonate-siloxane) compositions include less than 0.1 wt %, less than 0.05 wt %, less than 0.01 wt %, or 0.001 wt % titanium dioxide, based on the total weight of the composition. In some aspects, titanium dioxide is absent from the poly(carbonate-siloxane) compositions.

The poly(carbonate-siloxane) compositions can include a flame retardant. Useful flame retardants include organic compounds that include phosphorous, bromine, or chlorine. Non-brominated and non-chlorinated phosphorous-containing flame retardants can be preferred in certain applications for regulatory reasons, for example organic phosphates and organic compounds containing phosphorous-nitrogen bonds.

Halogenated materials can be used as flame retardants in the poly(carbonate-siloxane) compositions, for example halogenated compounds and polymers of formula (20):

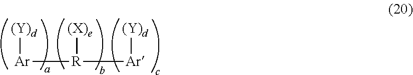

wherein R is an alkylene, alkylidene, or cycloaliphatic linkage (e.g., methylene, ethylene, propylene, isopropylene, isopropylidene, butylene, isobutylene, amylene, cyclohexylene, cyclopentylidene, and the like), a linkage selected from oxygen ether, carbonyl, amine, a sulfur containing linkage (e.g., sulfide, sulfoxide, or sulfone), a phosphorous containing linkage, and the like, or R can also consist of two or more alkylene or alkylidene linkages connected by such groups as aromatic, amino, ether, carbonyl, sulfide, sulfoxide, sulfone, a phosphorous containing linkage, and the like; Ar and Ar′ can be the same or different and are mono- or polycarbocyclic aromatic groups such as phenylene, biphenylene, terphenylene, naphthylene, and the like; Y is an organic, inorganic or organometallic radical such as halogen (e.g., chlorine, bromine, iodine, or fluorine), ether group of the general formula OE wherein E is a monovalent hydrocarbon radical similar to X, monovalent hydrocarbon groups of the type represented by R, or other substituents (e.g., nitro, cyano, or the like), the substituents being essentially inert provided there be at least one and preferably two halogen atoms per aryl nucleus; each X is the same or different, and is a monovalent hydrocarbon group such as alkyl (e.g., methyl, ethyl, propyl, isopropyl, butyl, decyl, and the like, aryl ((e.g., phenyl, naphthyl, biphenyl, xylyl, tolyl, and the like), arylalkylene (e.g., as benzyl, ethylenephenyl, and the like), cycloaliphatic (e.g., cyclopentyl, cyclohexyl, and the like), as well as monovalent hydrocarbon groups containing inert substituents therein; the letter d represents a whole number from 1 to a maximum equivalent to the number of replaceable hydrogens substituted on the aromatic rings comprising Ar or Ar′; the letter e represents a whole number from 0 to a maximum equivalent to the number of replaceable hydrogens on R; the letters a, b, and c represent whole numbers including 0, provided that when b is not 0, neither a nor c can be 0, or that either a or c, but not both, can be 0, or that where b is 0, the aromatic groups are joined by a direct carbon-carbon bond; the hydroxyl and Y substituents on the aromatic groups, Ar and Ar′ can be varied in the ortho, meta or para positions on the aromatic rings and the groups can be in any possible geometric relationship with respect to one another.

Included within the scope of the above formula are bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2 bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant.

Inorganic flame retardants can also be used, for example salts of C₂₋₁₆ alkyl sulfonates such as potassium perfluorobutane sulfonate (Rimar salt), potassium perfluoroctane sulfonate, and tetraethylammonium perfluorohexane sulfonate, salts of aromatic sulfonates such as sodium benzene sulfonate, sodium toluene sulfonate (NATS), and the like, salts of aromatic sulfone sulfonates such as potassium diphenylsulfone sulfonate (KSS), and the like; salts formed by reacting for example an alkali metal or alkaline earth metal (e.g., lithium, sodium, potassium, magnesium, calcium and barium salts) and an inorganic acid complex salt, for example, an oxo-anion (e.g., alkali metal and alkaline-earth metal salts of carbonic acid, such as Na₂CO₃, K₂CO₃, MgCO₃, CaCO₃, and BaCO₃, or a fluoro-anion complex such as Li₃AlF₆, BaSiF₆, KBF₄, K₃AlF₆, KAlF₄, K₂SiF₆, or Na₃AlF₆ or the like. Rimar salt and KSS and NATS, alone or in combination with other flame retardants, are particularly useful. Rimar salt and KSS and NATS, alone or in combination with other flame retardants, are particularly useful. The perfluoroalkyl sulfonate salt can be present in an amount of 0.30 to 1.00 wt %, preferably, 0.40 to 0.80 wt %, more preferably, 0.45 to 0.70 wt %, based on the total weight of the composition. The aromatic sulfonate salt can be present in composition in an amount of 0.01 to 0.1 wt %, preferably, 0.02 to 0.06 wt %, and more preferably, 0.03 to 0.05 wt %. Exemplary amounts of aromatic sulfone sulfonate salt can be 0.01 to 0.6 wt %, preferably, 0.1 to 0.4 wt %, and more preferably, 0.25 to 0.35 wt %, based on the total weight of the composition.

One type of organic phosphate is a monomeric aromatic phosphate of the formula (GO)₃P═O, wherein each G is independently a C₁₋₁₂ alkyl, C₃₋₈ cycloalkyl, C₆₋₁₂ aryl, C₇₋₁₃ alkylarylene, or C₇₋₁₃ arylalkylene group, provided that at least one G is an aromatic group. Two of the G groups can be joined together to provide a cyclic group. Aromatic phosphates include, for example, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

In the aromatic organophosphorous compounds that have at least one organic aromatic group, the aromatic group can be a substituted or unsubstituted C₃₋₃₀ group containing one or more of a monocyclic or polycyclic aromatic moiety (which can optionally contain with up to three heteroatoms (N, O, P, S, or Si)) and optionally further containing one or more nonaromatic moieties, for example alkyl, alkenyl, alkynyl, or cycloalkyl. The aromatic moiety of the aromatic group can be directly bonded to the phosphorous-containing group, or bonded via another moiety, for example an alkylene group. The aromatic moiety of the aromatic group can be directly bonded to the phosphorous-containing group, or bonded via another moiety, for example an alkylene group. In an aspect the aromatic group is the same as an aromatic group of the polycarbonate backbone, such as a bisphenol group (e.g., bisphenol A), a monoarylene group (e.g., a 1,3-phenylene or a 1,4-phenylene), or a combination comprising at least one of the foregoing.

The phosphorous-containing group can be a phosphate (P(═O)(OR)₃), phosphite (P(OR)₃), phosphonate (RP(═O)(OR)₂), phosphinate (R₂P(═O)(OR)), phosphine oxide (R₃P(═O)), or phosphine (R₃P), wherein each R in the foregoing phosphorous-containing groups can be the same or different, provided that at least one R is an aromatic group. A combination of different phosphorous-containing groups can be used. The aromatic group can be directly or indirectly bonded to the phosphorous, or to an oxygen of the phosphorous-containing group (i.e., an ester).

In an aspect the aromatic organophosphorous compound is a monomeric phosphate. Representative monomeric aromatic phosphates are of the formula (GO)₃P═O, wherein each G is independently an alkyl, cycloalkyl, aryl, alkylarylene, or arylalkylene group having up to 30 carbon atoms, provided that at least one G is an aromatic group. Two of the G groups can be joined together to provide a cyclic group. In some aspects G corresponds to a monomer used to form the polycarbonate, e.g., resorcinol. Exemplary phosphates include phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

Di- or polyfunctional aromatic organophosphorous compounds are also useful, for example, compounds of the formulas

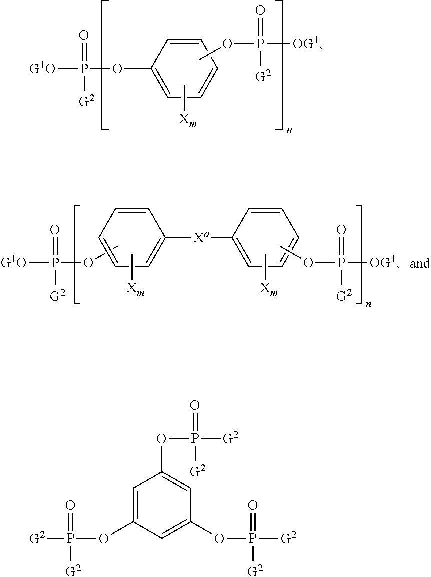

wherein each G¹ is independently a C₁₋₃₀ hydrocarbyl; each G² is independently a C₁₋₃₀ hydrocarbyl or hydrocarbyloxy; X^{a} is as defined in formula (3) or formula (4); each X is independently a bromine or chlorine; m is 0 to 4, and n is 1 to 30. In a specific aspect, X^{a} is a single bond, methylene, isopropylidene, or 3,3,5-trimethylcyclohexylidene.

Specific aromatic organophosphorous compounds are inclusive of acid esters of formula (9)

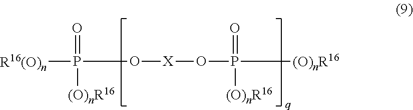

wherein each R¹⁶ is independently C₁₋₈ alkyl, C₅-6 cycloalkyl, C₆₋₂₀ aryl, or C₇₋₁₂ arylalkylene, each optionally substituted by C₁₋₁₂ alkyl, specifically by C₁₋₄ alkyl and X is a mono- or poly-nuclear aromatic C₆₋₃₀ moiety or a linear or branched C₂₋₃₀ aliphatic radical, which can be OH-substituted and can contain up to 8 ether bonds, provided that at least one R¹⁶ or X is an aromatic group; each n is independently 0 or 1; and q is from 0.5 to 30. In some aspects each R¹⁶ is independently C₁₋₄ alkyl, naphthyl, phenyl(C₁₋₄)alkylene, aryl groups optionally substituted by C₁₋₄ alkyl; each X is a mono- or poly-nuclear aromatic C₆₋₃₀ moiety, each n is 1; and q is from 0.5 to 30. In some aspects each R¹⁶ is aromatic, e.g., phenyl; each X is a mono- or poly-nuclear aromatic C₆₋₃₀ moiety, including a moiety derived from formula (2); n is one; and q is from 0.8 to 15. In other aspects, each R¹⁶ is phenyl; X is cresyl, xylenyl, propylphenyl, or butylphenyl, one of the following divalent groups

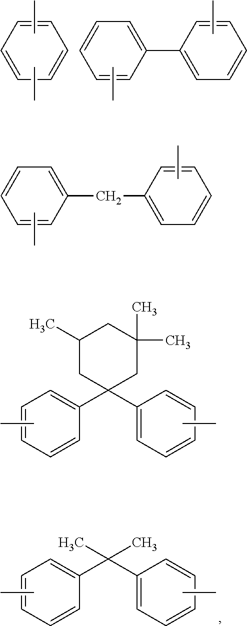

or a combination comprising one or more of the foregoing; n is 1; and q is from 1 to 5, or from 1 to 2. In some aspects at least one R¹⁶ or X corresponds to a monomer used to form the polycarbonate, e.g., bisphenol A, resorcinol, or the like. Aromatic organophosphorous compounds of this type include the bis(diphenyl) phosphate of hydroquinone, resorcinol bis(diphenyl phosphate) (RDP), and bisphenol A bis(diphenyl) phosphate (BPADP), and their oligomeric and polymeric counterparts.

The organophosphorous flame retardant containing a phosphorous-nitrogen bond can be a phosphazene, phosphonitrilic chloride, phosphorous ester amide, phosphoric acid amide, phosphonic acid amide, phosphinic acid amide, or tris(aziridinyl) phosphine oxide. These flame-retardant additives are commercially available. In an aspect, the organophosphorous flame retardant containing a phosphorous-nitrogen bond is a phosphazene or cyclic phosphazene of the formulas

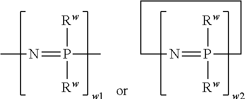

wherein w1 is 3 to 10,000; w2 is 3 to 25, or 3 to 7; and each R^{w} is independently a C₁₋₁₂ alkyl, alkenyl, alkoxy, aryl, aryloxy, or polyoxyalkylene group. In the foregoing groups at least one hydrogen atom of these groups can be substituted with a group having an N, S, O, or F atom, or an amino group. For example, each R^{w} can be a substituted or unsubstituted phenoxy, an amino, or a polyoxyalkylene group. Any given R^{w} can further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. In an aspect, the phosphazene has a structure represented by the formula

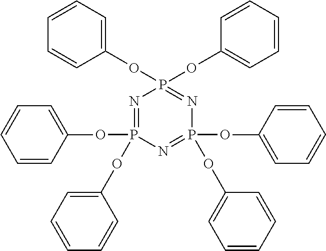 [SMILES: c1ccc(OP2(Oc3ccccc3)=NP(Oc3ccccc3)(Oc3ccccc3)=NP(Oc3ccccc3)(Oc3ccccc3)=N2)cc1]

Commercially available phenoxyphosphazenes having the aforementioned structures are LY202 manufactured and distributed by Lanyin Chemical Co., Ltd, FP-110 manufactured and distributed by Fushimi Pharmaceutical Co., Ltd, and SPB-100 manufactured and distributed by Otsuka Chemical Co., Ltd.

When present, the flame retardant comprising a copolymer of tetrabromophenol and bisphenol A, an organophosphorous compound, an alkyl sulfonate salt, or an aromatic sulfonate salt are generally present in amounts 0.1-20 wt %, 0.1-15 wt %, or 0.1-10 wt %, each based on the total weight of the poly(carbonate-siloxane) composition.

Anti-drip agents can also be used in the poly(carbonate-siloxane) compositions, for example a fibril forming or non-fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. TSAN comprises 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Anti-drip agents can be used in amounts of 0.01-10 wt %, 0.01-5 wt %, 0.01-1 wt %, or 0.1-0.5 wt %, each based on the total weight of the poly(carbonate-siloxane) composition.

An additive composition can be used, comprising one or more additives selected to achieve a desired property, with the proviso that the additive(s) are also selected so as to not significantly adversely affect a desired property of the composition. The additive composition or individual additives can be mixed at a suitable time during the mixing of the components for forming the composition. The additive can be soluble or non-soluble in polycarbonate. The additive composition can include an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, surface effect additive, radiation stabilizer, or a combination thereof. For example, a combination of a heat stabilizer, mold release agent, and ultraviolet light stabilizer can be used. In general, the additives are used in the amounts generally known to be effective. For example, the total amount of the additive composition can be 0.001 to 10.0 wt %, or 0.01 to 5 wt %, or 0.01-1 wt %, each based on the total weight of the poly(carbonate-siloxane) composition.

Heat stabilizer additives include organophosphites (e.g. triphenyl phosphite, tris-(2,6-dimethylphenyl)phosphite, tris-(mixed mono- and di-nonylphenyl)phosphite or the like), phosphonates (e.g, dimethylbenzene phosphonate or the like), phosphates (e.g., trimethyl phosphate, or the like), or a combination thereof. The heat stabilizer can be tris(2,4-di-t-butylphenyl) phosphate available as IRGAPHOS 168. Heat stabilizers are generally used in amounts of 0.01 to 5 wt %, or 0.01-1 wt %, based on the total weight the poly(carbonate-siloxane) composition.

There is considerable overlap among plasticizers, lubricants, and mold release agents, which include, for example, phthalic acid esters (e.g, octyl-4,5-epoxy-hexahydrophthalate), tris-(octoxycarbonylethyl)isocyanurate, di- or polyfunctional aromatic phosphates (e.g., resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); fatty acid esters (e.g, C₁₋₃₂ alkyl stearyl esters, such as methyl stearate and stearyl stearate and esters of stearic acid such as pentaerythritol tetrastearate (PETS), glycerol tristearate (GTS), and the like), waxes (e.g, beeswax, montan wax, paraffin wax, or the like), or a combination thereof. These are generally used in amounts of 0.01 to 5 wt %, or 0.01-1 wt %, based on the total weight the poly(carbonate-siloxane) composition.

The poly(carbonate-siloxane) compositions can be manufactured by various methods. For example, powdered polycarbonate, poly(carbonate-siloxane), the colorant composition, or other optional components are first blended, optionally with fillers in a HENSCHEL-Mixer high speed mixer. Other low shear processes, including but not limited to hand mixing, can also accomplish this blending. The composition is then fed into the throat of a twin-screw extruder via a hopper. Alternatively, at least one of the components can be incorporated into the composition by feeding directly into the extruder at the throat or downstream through a sidestuffer. Additives can also be compounded into a masterbatch with a desired polymeric polymer and fed into the extruder. The extruder is generally operated at a temperature higher than that necessary to cause the composition to flow. The extrudate is immediately quenched in a water bath and pelletized. The pellets so prepared can be one-fourth inch long or less as desired. Such pellets can be used for subsequent molding, shaping, or forming.

Shaped, formed, or molded articles comprising the polycarbonate compositions are also provided. The polycarbonate compositions can be molded into useful shaped articles by a variety of methods, such as injection molding, extrusion, rotational molding, blow molding and thermoforming. Some example of articles include computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like.

Molded samples of the poly(carbonate-siloxane) compositions can be substantially free of pearlescence. As used herein, “substantially free of pearlescence” means that greater than 85%, preferably greater than 90%, more preferably 95% of the surface area of the molded sample is free of pearlescence. As discussed below in the Examples, molded samples of the poly(carbonate-siloxane) compositions in which the siloxane content of the poly(carbonate-siloxane) copolymer ranged from greater than 25 wt % to 70 wt % (e.g., 40 wt %) were substantially free of pearlescence. When present, the pearlescence was very minor and was confined to the gate.

The colors of molded samples of the poly(carbonate-siloxane) compositions can be described using the CIE LAB color scale. Test methods used to determine the color properties of the compositions include ASTM 2244, ASTM E308, ASTM, E1164, ASTM E2194, DIN 5033, DIN5036, DIN6174, DIN6175-2, and ISO7724. When a color is expressed in CIELAB, the “L* value” describes the lightness-darkness property. If the L* value=0, the object is black. If the L* value=100 the object is white. The L* value is always positive. The color properties of the composition may also be defined using the “a*” and “b*” values. The designation a* denotes how green or red a color is, whereas b* represents how blue or yellow a color is. The “a*” value describes the position on a red-green axis. If a* is positive, the shade is red and if a* is negative, the shade is green. The b* value describes the position on a yellow-blue axis. If b* is positive, the shade is yellow and if b* is negative, the shade is blue. When a* and b* are near zero and L* is smaller, the result is a darker, more intense color for the composition.

Molded samples of the poly(carbonate-siloxane) compositions having a black color can have an average L*(SCE) value and an average C*(SCE) value measured by the CIE LAB method, 10 degree observer, D65 illuminant, specular component excluded, in reflectance mode. The average L*(SCE) value can be less than 15, less than 10, less than 8, or less than 5. The average C*(SCE) value can be less than 20, less than 15, less than 10, less than 5, or less than 3.

Molded samples of the poly(carbonate-siloxane) compositions having a black color can have an average L*(SCI) value and an average C*(SCI) value measured by the CIE Lab method, 10 degree observer, D65 illuminant, specular component included, in reflectance mode. The average L*(SCI) value can be less than 30. The average L*(SCI) value can be less than 10, less than 5, less than 3, or less than 2.

Changes in color from multiple viewing angles can be measured for molded samples (2 inch×3 inch color plaques) of the poly(carbonate-siloxane) compositions using a Gonio spectrophotometer, also called a multi-angle spectrophotometer (Illuminant D65, C, or CWF). For example, the viewing angles can be −15, 15, 25, 34, 75, and 100° as measured from the specular component. Illumination can be at 45° and the specular component can be at 45° where the angle between the lamp and specular component is 90°. As the viewing angle increases or decreases in a range from 0° to 180°, observed color differences can be expressed as DE*, DL*, Da*, Db*, DC*, and DH*.

This disclosure is further illustrated by the following examples, which are non-limiting.

### EXAMPLES

The materials shown in Table 1 were used.

TABLE 1

| Component | Description (Trade name) | Source |
|---|---|---|
| PC-Si-40-1 | PDMS (polydimethylsiloxane)-Bisphenol A polycarbonate copolymer, 40 wt % | SABIC |
| | siloxane, average PDMS block length 45 units (D45), Mw 37,000 to 38,000 g/mol | |
| | as determined by GPC using polycarbonate standards, eugenol end-capped | |
| PC-40-2 | PDMS (polydimethylsiloxane)-Bisphenol A polycarbonate copolymer, 40 wt % | SABIC |
| | siloxane, average PDMS block length 45 units (D45), Mw 44,000 to 46,000 g/mol | |
| | as determined by GPC using polycarbonate standards, eugenol end-capped | |
| PC-Si-20 | PDMS (polydimethylsiloxane)-Bisphenol A polycarbonate copolymer, 20 wt % | SABIC |
| | siloxane, average PDMS block length 45 units (D45), Mw 29,000 to 31,000 g/mol | |
| | as determined by GPC using polycarbonate standards, eugenol end-capped | |
| PC-1 | Linear Bisphenol A polycarbonate homopolymer, produced via interfacial | SABIC |
| | polymerization, Mw 21,000-23,000 g/mol, as determined by GPC using | |
| | polystyrene standards and calculated for polycarbonate. | |
| PC-2 | Linear Bisphenol A polycarbonate homopolymer, produced via interfacial | SABIC |
| | polymerization, Mw 29,000-31,000 g/mol, as determined by GPC using | |
| | polycarbonate standards. | |
| BLACK | Carbon black, available as Pigment Black 6 | CABOT |
| INORGANIC | Pigment Red 265 (cerium sulfide) | COLORCHEM |
| RED | | |
| WHITE | Pigment White (titanium dioxide) | KRONOS |
| INORGANIC | Pigment Green 50 (cobalt titanate) | FERRO |
| GREEN | | |
| ORGANIC | Pigment Blue 15.4 (copper phthalocyanine) | SUN |
| BLUE | | CHEMICAL |
| ORGANIC | Solvent Red 135 (perinone) | LANXESS |
| RED | | |
| ORGANIC | Solvent Green 3 (anthraquinone) | LANXESS |
| GREEN | | |
| PETS | Pentaerythritol tetrastearate | FACI |
| STAB | Tris(2,4-di-tert-butylphenyl) phosphite (IRGAFOS 168) | BASF |

The samples were prepared as described below and the following test methods were used.

All powder additives were combined together with the polycarbonate powder(s), using a paint shaker, and fed through one feeder to an extruder. Extrusion for all combinations was performed on a 26 mm twin screw extruder, using a melt temperature of 270-320° C. and 300 revolutions per minute (rpm), then pelleted. The pellets were dried for 3 hours at 100° C. Dried pellets were injection molded at temperatures of 270-300° C. to form specimens for most of the tests below.

The presence of pearlescence was determined by visual inspection of the color plaques prepared from each composition. Color plaques having a 2.54 mm thickness were prepared from each composition by injection molding. The color plaques were viewed with a 185 lumen LED light source (3730 candela peak beam intensity) at multiple viewing angles with a Macbeth ColorEye 7000A integrating sphere spectrophotometer using D75 illuminant, 10 Degree observer.

The melt volume flow rate (MVR) of the compositions can be determined using ISO 1133 or ASTM D1238. MVR measures the mass of a composition extruded through an orifice at a prescribed temperature and load over a prescribed time period. The higher the MVR value of a polymer composition at a specific temperature, the greater the flow of that composition at that specific temperature. The melt volume flow rate of the compositions can be measured at 300° C. and a 1.2 kg load.

SEM photographs (results not shown) were taken at 20,000 magnification of three compositions that included a combination of poly(carbonate-siloxane) and BPA homopolycarbonate. The first composition included 30 wt % a poly(carbonate-siloxane) copolymer having 20 wt % siloxane content and had an average domain size of 123 nm. The second composition included 15 wt % a poly(carbonate-siloxane) copolymer having 40 wt % siloxane content and had an average domain size of 44 nm. The third composition included 10 wt % a poly(carbonate-siloxane) copolymer having 60 wt % siloxane content and had an average domain size of 55 nm. Although each composition had a total siloxane content of 6 wt % siloxane, it was only the compositions wherein the siloxane content of the poly(carbonate-siloxane) was greater than 20 wt % (e.g., 40 wt % and 60 wt %) where the average domain size was 100 nm or less. Having an average domain size of 100 nm or less correlates with a molded sample being substantially free of pearlescence when colorant is added as demonstrated below.

Table 2 shows the composition and properties of Examples 1-10.

TABLE 2

| | | 1 | 2 | 3 | 4 | 5 | 6* | 7* | 8* | 9* | 10* |
|---|---|---|---|---|---|---|---|---|---|---|---|
| PC 1 | wt % | 52.1 | 51.3 | 51.1 | 50.6 | 52.3 | 40.1 | 39.3 | 39.1 | 38.6 | 40.3 |
| PC 2 | wt % | 35.0 | 35.0 | 35.0 | 35.0 | 35.0 | 35.0 | 35.0 | 35.0 | 35.0 | 35.0 |
| PC-Si-40-1 | wt % | 12 | 12 | 12 | 12 | 12 | | | | | |
| PC-Si-20 | wt % | | | | | | 24 | 24 | 24 | 24 | 24 |
| PETS | wt % | 0.3 | 0.3 | 0.3 | 0.3 | 0.3 | 0.3 | 0.3 | 0.3 | 0.3 | 0.3 |
| STAB | wt % | 0.1 | 0.1 | 0.1 | 0.1 | 0.1 | 0.1 | 0.1 | 0.1 | 0.1 | 0.1 |
| BLACK | wt % | 0.5 | 0.5 | 0.5 | 0.5 | | 0.5 | 0.5 | 0.5 | 0.5 | |
| WHITE | wt % | | 0.8 | | | | | 0.8 | | | |
| INORGANIC | wt % | | | 0.25 | 0.25 | | | | 0.25 | 0.25 | |
| RED | | | | | | | | | | | |
| INORGANIC | wt % | | | 0.6 | 0.6 | | | | 0.6 | 0.6 | |
| GREEN | | | | | | | | | | | |
| ORGANIC | wt % | | | 0.13 | 0.13 | | | | 0.13 | 0.13 | |
| BLUE | | | | | | | | | | | |
| ORGANIC | wt % | | | | 0.285 | | | | | 0.285 | |
| RED | | | | | | | | | | | |
| ORGANIC | wt % | | | | 0.215 | 0.3 | | | | 0.215 | 0.3 |
| GREEN | | | | | | | | | | | |
| Total | wt % | 100 | 100 | 99.98 | | | | | | | |
| Pearlescence, | | No | No | No | No | No | Yes | No | Yes | Yes | Yes |
| main chip | | | | | | | | | | | |
| surface | | | | | | | | | | | |
| Pearlescence, | | No | No | No | No | Minor | Yes | No | Yes | Yes | Yes |
| gate region of | | | | | | | | | | | |
| chip | | | | | | | | | | | |
| MVR- | cm³/ | 8.43 | 8.98 | 11 | 10.2 | 10.8 | 7.64 | 8.2 | 9.66 | 10.1 | 8.89 |
| ASTMD | 10 | | | | | | | | | | |
| 1238 | min | | | | | | | | | | |

Examples 1-5 include a combination of homopolycarbonate (PC-1 and PC-2) and poly(carbonate-siloxane) having a 40 wt % siloxane content and a molecular weight of 37,000-38000 g/mol provided molded samples wherein pearlescence was minimized or reduced. In particular, as shown in Examples 1-4, when 0.5 wt % of carbon black was present, pearlescence was eliminated. Example 5 shows that when organic green was the sole colorant in the composition at a loading level of 0.3 wt %, pearlescence was not observed on the main surface of the color chip whereas a minor amount of pearlescence was observed at the gate region of the color chip. Comparative Examples 6 and 8-10 shows that when the poly(carbonate-siloxane) having a 40 wt % siloxane content was replaced with a poly(carbonate-siloxane) having a 20 wt % siloxane content, pearlescence was observed for both the main surface of the color chip and at the gate region. In a similar composition wherein a combination of carbon black (0.5 wt % of carbon black and 0.8 wt % of titanium dioxide) resulted in the elimination of pearlescence was observed for both the main surface of the color chip and at the gate region.

Table 3 shows the composition and properties of Examples 11-15.

TABLE 3

| | | 11 | 12 | 13 | 14 | 15 |
|---|---|---|---|---|---|---|
| PC 1 | wt % | 52.1 | 51.3 | 51.1 | 50.6 | 52.3 |
| PC 2 | wt % | 35.0 | 35.0 | 35.0 | 35.0 | 35.0 |
| PC-Si-40-2 | wt % | 12 | 12 | 12 | 12 | 12 |
| PETS | wt % | 0.3 | 0.3 | 0.3 | 0.3 | 0.3 |
| STAB | wt % | 0.1 | 0.1 | 0.1 | 0.1 | 0.1 |
| BLACK | wt % | 0.5 | 0.5 | 0.5 | 0.5 | |
| WHITE | wt % | | 0.8 | | | |
| INORGANIC | wt % | | | 0.25 | 0.25 | |
| RED | | | | | | |
| INORGANIC | wt % | | | 0.6 | 0.6 | |
| GREEN | | | | | | |
| ORGANIC | wt % | | | 0.13 | 0.13 | |
| BLUE | | | | | | |
| ORGANIC | wt % | | | | 0.285 | |
| RED | | | | | | |
| ORGANIC | wt % | | | | 0.215 | 0.3 |
| GREEN | | | | | | |
| Total | wt % | 100 | 100 | 100 | 100 | 100 |
| Pearlescence, | | No | No | No | No | No |
| main chip | | | | | | |
| surface | | | | | | |
| Pearlescence, | | No | No | No | No | Minor |
| gate region of | | | | | | |
| chip | | | | | | |
| MVR- | cm³/ | 7.66 | 7.88 | 9.26 | 9.82 | 9.73 |
| ASTMD | 10 | | | | | |
| 1238 | min | | | | | |

*Comparative Examples

Examples 11-15 include a combination of homopolycarbonate (PC-1 and PC-2) and poly(carbonate-siloxane) having a 40 wt % siloxane content and a molecular weight of 44,000-46,000 g/mol provided molded samples wherein pearlescence was minimized or reduced. In particular, as shown in Examples 1-4, when 0.5 wt % of carbon black was present, pearlescence was eliminated. Example 5 shows that when organic green was the sole colorant in the composition at a loading level of 0.3 wt %, pearlescence was not observed on the main surface of the color chip whereas a minor amount of pearlescence was observed at the gate region of the color chip. Comparative Examples 6 and 8-10 show that when the poly(carbonate-siloxane) having a 40 wt % siloxane content was replaced with a poly(carbonate-siloxane) having a 20 wt % siloxane content, pearlescence was observed for both the main surface of the color chip and at the gate region. In a similar composition wherein a combination of carbon black (0.5 wt % of carbon black and 0.8 wt % of titanium dioxide) resulted in the elimination of pearlescence was observed for both the main surface of the color chip and at the gate region.

This disclosure further encompasses the following aspects.

Aspect 1. A poly(carbonate-siloxane) composition comprising: a poly(carbonate-siloxane) copolymer comprising carbonate units and siloxane units, wherein a siloxane content is greater than 25 wt % to less than 70 wt %, based on the total weight of the poly(carbonate-siloxane) copolymer, wherein the weight average molecular weight of the poly(carbonate-siloxane) copolymer is greater than 30,000 g/mol, as measured by gel permeation chromatography using a crosslinked styrene-divinyl benzene column, using polystyrene standards and calculated for polycarbonate; a homopolycarbonate comprising a bisphenol A homopolycarbonate; a colorant composition comprising an organic colorant, an inorganic pigment, or a combination thereof wherein the colorant composition optionally comprises titanium dioxide in an amount of 0.8 wt % or less; optionally, a flame retardant; optionally, an anti-drip agent; and optionally, an additive composition, wherein an average siloxane domain size is less than 100 nanometers as determined by scanning electron microscopy.

Aspect 2: The poly(carbonate-siloxane) composition of Aspect 1 wherein the organic colorant comprises carbon black, an azo compound, a di-azo compound, amethine compound, a coumarin compound, a pyrazolone compound, a quinophthalone compound, a quinacridone compound, a perylene compound, a perinone compound, a naphthalene tetracarboxylic acid compound, a flavanthrone compound, an isoindolinone compound, a tetrachloroisoindolinone compound, an anthraquinone compound, an enthrone compound, an anthracene compound, an indigoid compound, a thioindigoid compound, an imidazole compound, a naphthalimide compound, a xanthene compound, a thioxanthene compound, an azine compound, a rhodamine compound, a dioxazine compound, a phthalocyanine compound, an azo lake compound, or a combination thereof; the inorganic pigment comprises a titanate, an aluminate, a carbonate, a zinc oxide, an iron oxide, a chromium oxide, an ultramarine, a metal sulfide, or a combination thereof.

Aspect 3. The poly(carbonate-siloxane) composition of Aspect 1 or Aspect 2 comprising: 5-30 wt % of the poly(carbonate-siloxane) copolymer; 70-95 wt % of bisphenol A homopolycarbonate; and 0.001-3.0 wt % of the colorant composition.

Aspect 4: The poly(carbonate-siloxane) composition of any one of the preceding aspects, wherein the siloxane content of the poly(carbonate-siloxane) copolymer is 35-65 wt %, preferably 35-55 wt %, or more preferably 35-45 wt %, each based on the total weight of the poly(carbonate-siloxane) copolymer.

Aspect 5. The poly(carbonate-siloxane) composition of any one of the preceding aspects, wherein the poly(carbonate-siloxane) has a weight average molecular weight of greater than 30,000 to 50,000 grams per mole as measured by gel permeation chromatography using a crosslinked styrene-divinyl benzene column, using polystyrene standards and calculated for polycarbonate.

Aspect 6. The poly(carbonate-siloxane) composition of any one of the preceding aspects, wherein the siloxane content is from 2-10 wt %, or from 4-10 wt %, based on the total weight of the composition.

Aspect 7. The poly(carbonate-siloxane) composition of one of the preceding aspects, wherein the organic colorant comprises 0.1-1 wt % carbon black, based on the total weight of the composition, and wherein the poly(carbonate-siloxane) composition has a jet-black appearance.

Aspect 8. The poly(carbonate-siloxane) composition of one of the preceding aspects, wherein the colorant composition comprises 0.001-1.5 wt % carbon black, copper phthalocyanine, perinone, anthraquinone, or a combination thereof as the organic colorant; 0.001-1.5 wt % cerium sulfide, cobalt titanate, or a combination thereof, as the inorganic pigment; or a combination thereof, each based on the total weight of the composition.

Aspect 9. The poly(carbonate-siloxane) composition of one of the preceding aspects comprising 0.1-10 wt % of the flame retardant comprising a copolymer of tetrabromophenol and bisphenol A, an organophosphorous compound, an alkyl sulfonate salt, an aromatic sulfonate salt, or a combination thereof; 0.1-1 wt % of the anti-drip agent comprising styrene-acrylonitrile-encapsulated PTFE; or a combination thereof.

Aspect 10. The poly(carbonate-siloxane) composition of any one of the preceding aspects, wherein the carbonate units of the poly(carbonate-siloxane) copolymer are derived from bisphenol A and the siloxane units are of formula (7)

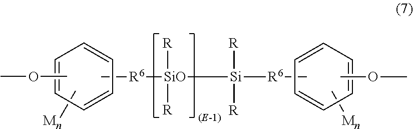

wherein each occurrence of R is C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, or C₇₋₁₃ alkylarylene; E has an average value of 5 to 100; each occurrence of R⁶ is a divalent C₂-C₈ aliphatic group; each occurrence of M is independently a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ arylalkylene, or C₇₋₁₂ alkylarylene; and each occurrence of n is 0, 1, 2, 3, or 4

Aspect 11. The poly(carbonate-siloxane) composition of any one of the preceding aspects, wherein the homopolycarbonate comprises a bisphenol A homopolycarbonate having a weight average molecular weight of 18,000 to 23,000 g/mol; a bisphenol A homopolycarbonate having a weight average molecular weight of 27,000 to 35,000 g/mol; or a combination thereof, each as measured by gel permeation chromatography (GPC), using a crosslinked styrene-divinylbenzene column using polystyrene standards and calculated for polycarbonate.

Aspect 12. The poly(carbonate-siloxane) composition of any one of the preceding aspects comprising 5-30 wt % of the poly(carbonate-siloxane) copolymer having a 35-45 wt % siloxane content, based on the total weight of the poly(carbonate-siloxane) copolymer; 70-95 wt % of the bisphenol A homopolycarbonate; and 0.001-3 wt % of the colorant composition.

Aspect 13. An article comprising the poly(carbonate-siloxane)composition of any one of the preceding aspects, wherein the article is an extruded article, a molded article, pultruded article, a thermoformed article, a foamed article, a layer of a multi-layer article, a substrate for a coated article, or a substrate for a metallized article, preferably wherein the article is a molded article.

Aspect 14. A method for forming the article of Aspect 13, comprising molding, casting, or extruding the article.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of compositions, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some aspects”, “an aspect”, and so forth, means that a particular element described in connection with the aspect is included in at least one aspect described herein, and may or may not be present in other aspects. In addition, it is to be understood that the described elements may be combined in any suitable manner in the various aspects. A “combination thereof” is open and includes any combination comprising at least one of the listed components or properties optionally together with a like or equivalent component or property not listed

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl) a thiol (—SH), a thiocyano (—SCN), a tosyl (CH₃C₆H₄SO₂—), a C₃₋₁₂ cycloalkyl, a C₂₋₁₂ alkenyl, a C₅-12 cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A poly(carbonate-siloxane) composition comprising:
a poly(carbonate-siloxane) copolymer comprising carbonate units and siloxane units, wherein a siloxane content is greater than 25 wt % to less than 70 wt %, based on the total weight of the poly(carbonate-siloxane) copolymer and wherein the weight average molecular weight of the poly(carbonate-siloxane) copolymer is greater than 30,000 g/mol, as measured by gel permeation chromatography using a crosslinked styrene-divinyl benzene column, using polystyrene standards and calibrated for polycarbonate;
a homopolycarbonate comprising a bisphenol A homopolycarbonate;
a colorant composition comprising an organic colorant, an inorganic pigment, or a combination thereof, wherein the colorant composition optionally comprises titanium dioxide in an amount of 0.8 wt % or less;
optionally, a flame retardant;
optionally, an anti-drip agent, and
optionally, an additive composition,
wherein an average siloxane domain size is less than 100 nanometers as determined by scanning electron microscopy.

2. The poly(carbonate-siloxane) composition of claim 1, wherein
the organic colorant comprises carbon black, an azo compound, a di-azo compound, a methine compound, a coumarin compound, a pyrazolone compound, a quinophthalone compound, a quinacridone compound, a perylene compound, a perinone compound, a naphthalene tetracarboxylic acid compound, a flavanthrone compound, an isoindolinone compound, a tetrachloroisoindolinone compound, an anthraquinone compound, an enthrone compound, an anthracene compound, an indigoid compound, a thioindigoid compound, an imidazole compound, a naphthalimide compound, a xanthene compound, a thioxanthene compound, an azine compound, a rhodamine compound, a dioxazine compound, a phthalocyanine compound, an azo lake compound, or a combination thereof;
the inorganic pigment comprises a titanate, an aluminate, a carbonate, a zinc oxide, an iron oxide, a chromium oxide, an ultramarine, a metal sulfide, or a combination thereof.

3. The poly(carbonate-siloxane) composition of claim 1 comprising:
5-30 wt % of the poly(carbonate-siloxane) copolymer;
70-95 wt % of bisphenol A homopolycarbonate; and
0.001-3.0 wt % of the colorant composition.

4. The poly(carbonate-siloxane) composition of claim 1, wherein the siloxane content of the poly(carbonate-siloxane) copolymer is 35-65 wt %, each based on the total weight of the poly(carbonate-siloxane) copolymer.

5. The poly(carbonate-siloxane) composition of claim 1, wherein the poly(carbonate-siloxane) has a weight average molecular weight of greater than 30,000 to 50,000 grams per mole as measured by gel permeation chromatography using a crosslinked styrene-divinyl benzene column, using polystyrene standards and calculated for polycarbonate.

6. The poly(carbonate-siloxane) composition of claim 1, wherein the siloxane content is from 2-10 wt %, based on the total weight of the composition.

7. The poly(carbonate-siloxane) composition of claim 1, wherein the organic colorant comprises 0.1-1 wt % carbon black, based on the total weight of the composition, and wherein the poly(carbonate-siloxane) composition has a j et-black appearance.

8. The poly(carbonate-siloxane) composition of claim 1, wherein the colorant composition comprises
0.001-1.5 wt % carbon black, copper phthalocyanine, perinone, anthraquinone, or a combination thereof as the organic colorant;
0.001-1.5 wt % cerium sulfide, cobalt titanate, or a combination thereof, as the inorganic pigment;
or a combination thereof,
each based on the total weight of the composition.

9. The poly(carbonate-siloxane) composition of claim 1 comprising
0.1-20 wt % of the flame retardant comprising a copolymer of tetrabromophenol and bisphenol A, an organophosphorous compound, an alkyl sulfonate salt, an aromatic sulfonate salt, or a combination thereof;
0.1-1 wt % of the anti-drip agent comprising styrene-acrylonitrile-encapsulated PTFE;
or a combination thereof.

10. The poly(carbonate-siloxane) composition of claim 1, wherein the carbonate units of the poly(carbonate-siloxane) copolymer are derived from bisphenol A and the siloxane units are of formula (7) 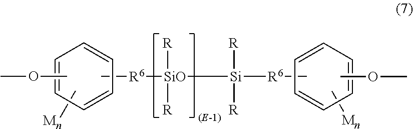
wherein
each occurrence of R is C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, or C₇₋₁₃ alkylarylene;
E has an average value of 5 to 100;
each occurrence of R⁶ is a divalent C₂-C₈ aliphatic group;
each occurrence of M is independently a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ arylalkylene, or C₇₋₁₂ alkylarylene; and
each occurrence of n is 0, 1, 2, 3, or 4.

11. The poly(carbonate-siloxane) composition of claim 1, wherein
the homopolycarbonate comprises
a bisphenol A homopolycarbonate having a weight average molecular weight of 18,000 to 23,000 g/mol;
a bisphenol A homopolycarbonate having a weight average molecular weight of 27,000 to 35,000 g/mol; or a combination thereof,
each as measured by gel permeation chromatography (GPC), using a crosslinked styrene-divinylbenzene column and calibrated to bisphenol A homopolycarbonate references;
or a combination thereof.

12. The poly(carbonate-siloxane) composition of claim 1 comprising
5-30 wt % of the poly(carbonate-siloxane) copolymer having a 35-45 wt % siloxane content, based on the total weight of the poly(carbonate-siloxane) copolymer;
70-95 wt % of the bisphenol A homopolycarbonate; and
0.001-3 wt % of the colorant composition.

13. An article comprising the poly(carbonate-siloxane) composition of claim 1, wherein the article is an extruded article, a molded article, pultruded article, a thermoformed article, a foamed article, a layer of a multi-layer article, a substrate for a coated article, or a substrate for a metallized article.

14. A method for forming the article of claim 13, comprising molding, casting, or extruding the article.

15. The poly(carbonate-siloxane) composition of claim 6, wherein the siloxane content is 4-10 wt % based on the total weight of the composition.

16. The poly(carbonate-siloxane) composition of claim 1, wherein the siloxane content of the poly(carbonate-siloxane) copolymer is 35-55 wt % based on the total weight of the poly(carbonate-siloxane) copolymer.

17. The poly(carbonate-siloxane) composition of claim 1, wherein the siloxane content of the poly(carbonate-siloxane) copolymer is 35-45 wt %, based on the total weight of the poly(carbonate-siloxane) copolymer.

18. The article of claim 13, wherein the article is a molded article.
